(19) United States
(12) Patent Application Publication
(10) Pub. No.: US 2009/0067906 A1
(43) Pub. Date: Mar. 12, 2009

(54) IMAGE FORMING APPARATUS AND CONTROL METHOD OF THE SAME

(75) Inventor: Norio TANAKA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,020

(22) Filed: Sep. 9, 2008

Related U.S. Application Data
(60) Provisional application No. 60/971,550, filed on Sep. 11, 2007.

(51) Int. Cl. G03G 15/00

(52) U.S. Cl. 399/388

(57) ABSTRACT

One paper sheet is extracted from a paper feeding cassette and fed to a process unit by plural rollers that are actuated by motors, respectively. In printing, the motors are actuated at low speed when first paper sheet is fed from the paper feeding cassette to the process unit and are actuated at high speed when second and subsequent paper sheets are fed to the process unit.

### CROSS-REFERENCE TO RELATED APPLICATION

This application is based upon and claims the benefit of priority from U.S. Provisional Application No. 60/971,550 filed on Sep. 11, 2007, the entire contents of which are incorporated herein by reference.

### TECHNICAL FIELD

The present invention relates to an image forming apparatus and a control method of the same for extracting a paper sheet in a paper feeding cassette and feeding the paper sheet to a process unit.

### BACKGROUND

An image forming apparatus that can perform monochrome printing and color printing includes plural photoconductive drums corresponding to yellow (Y), magenta (M), cyan (C), and black (K), respectively, and also includes an exposing unit, plural developing units, a transfer belt, plural primary transfer rollers, a secondary transfer roller, and a fixing unit.

The exposing unit exposes the surfaces of the photoconductive drums with laser beams to thereby form electrostatic latent images on the surfaces of the photoconductive drums, respectively. The developing units develop the electrostatic latent images formed on the surfaces of the photoconductive drums with yellow, magenta, cyan, and black developers to visualize the electrostatic latent images, respectively. The transfer belt rotates while coming into contact with the surfaces of the respective photoconductive drums. The primary transfer rollers rotate while pressing the transfer belt against and bringing the same into contact with the surfaces of the photoconductive drums to thereby transfer visible images on the photoconductive drums onto the transfer belt, respectively. The secondary transfer roller transfers the visible images of the respective colors transferred onto the transfer belt onto a paper sheet. The fixing unit applies heat to the paper sheet having the visible images transferred thereon to fix the visible images on the paper sheet. Printing of an image is completed by the fixing of the visible images.

Paper sheets are stored in at least one paper feeding cassette. A conveying path for the paper sheets is provided from the paper feeding cassette to the secondary transfer roller. A pickup roller and a paper feeding roller are provided in positions opposed to the paper feeding cassette. Conveying rollers and registration rollers are provided in the conveying path.

The pickup roller extracts one paper sheet in the paper feeding cassette. The paper feeding roller delivers the paper sheet extracted by the pickup roller to the conveying path. The conveying rollers feed the paper sheet delivered to the conveying path to the registration rollers. The registration rollers once put the paper sheet supplied from the conveying rollers on standby and feed the paper sheet into between the transfer belt and the secondary transfer roller at timing when a top position of the visible images on the transfer belt and a leading end of the paper sheet coincide with each other. The visible images on the transfer belt are transferred onto the paper sheet fed into between the transfer belt and the secondary transfer roller.

The pickup roller, the paper feeding roller, the conveying rollers, and the registration rollers are driven by motors, respectively.

In such an image forming apparatus, the paper sheet being conveyed may hit a guide member of the conveying path. When the paper sheet hits the guide member, large sound is generated.

To cope with the generation of such sound, in JP-A-2000-1245, the speed of the conveying rollers is set high in the transfer of a first sheet and set low in the transfer of second and subsequent sheets.

### SUMMARY

When the speed of the conveying rollers is set low in transferring the second and subsequent sheets, printing speed falls.

During the start of printing, it is necessary to wait for startup of various components. Therefore, even if the speed of the conveying rollers is high in transferring the first sheet, it comes to a useless operation. Moreover, large sound echoes in a silent room and a user feels unpleasant.

It is an object of an aspect of the present invention to provide an image forming apparatus and a control method of the same that can reduce noise during the start of printing.

An image forming apparatus according to an aspect of the present invention includes: a process unit which includes image bearing members and prints images formed on the image bearing members on a paper sheet; at least one paper feeding cassette which stores the paper sheet; plural rollers which extract one paper sheet from the paper feeding cassette and feed the extracted paper sheet to the process unit; motors which drive the rollers; and a motor control section which actuates, in the printing, the motors at low speed when a first paper sheet is fed from the paper feeding cassette to the process unit and actuates the motors at high speed when second and subsequent paper sheets are fed to the process unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the preferred embodiments given below, serve to explain the principles of the invention.

FIG. 1 is a diagram showing a general configuration of an embodiment of the present invention;

FIG. 2 is a diagram showing a configuration around each of photoconductive drums shown in FIG. 1;

FIG. 3 is a diagram showing a configuration of respective rollers for paper feeding and motors for driving the rollers in FIG. 1;

FIG. 4 is a block diagram showing a control circuit according to the embodiment;

FIG. 5 is a block diagram showing an exposing unit shown in FIG. 1;

FIG. 6 is a block diagram showing a main part of a sheet conveying unit shown in FIG. 1; and

FIG. 7 is a flowchart for explaining actions in the embodiment.

### DETAILED DESCRIPTION

An embodiment of the present invention is explained below with reference to the accompanying drawings.

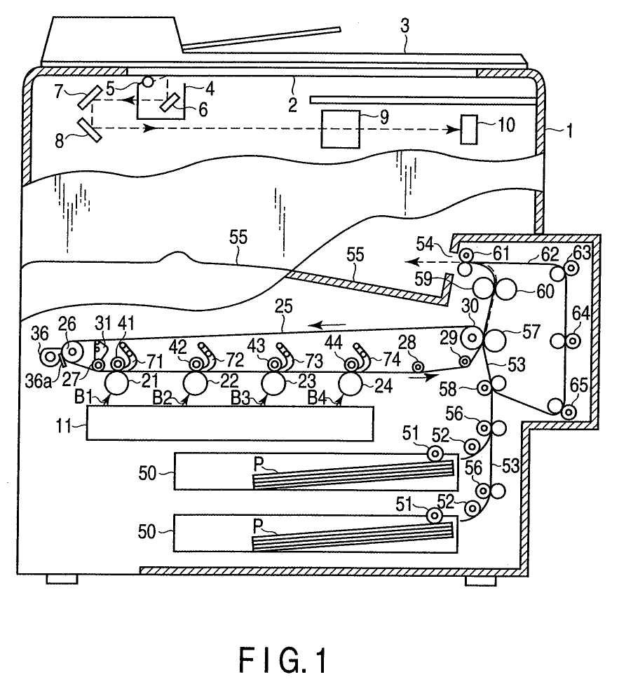

As shown in FIG. 1, a transparent original glass (a glass plate) 2 for placing an original is provided in an upper part of a main body 1. A cover 3 is openably and closably provided on the original glass 2. A carriage 4 is provided on a lower surface side of the original glass 2. An exposure lamp 5 is provided in the carriage 4. The carriage 4 can reciprocatingly move along the lower surface of the original glass 2. The exposure lamp 5 is turned on while the carriage 4 is moving forward, whereby an original D on the original glass 2 is exposed to light. A reflected light image of the original D on the original glass 2 is obtained by the exposure. The reflected light image is projected on a CCD (Charge Coupled Device) 10 by reflection mirrors 6, 7, and 8 and a magnification lens block 9. The CCD 10 outputs an image signal of a level corresponding to the reflected light image of the original D.

A scanning unit which optically scans an image of the original D placed on the original glass 2 is configured by the carriage 4, the exposure lamp 5, the reflection mirrors 6, 7, and 8, the magnification lens block 9, and the CCD 10.

Image signals outputted from the CCD 10 are supplied to an exposing unit 11 after being appropriately processed. The exposing unit 11 emits a laser beam B1 corresponding to a yellow image signal, a laser beam B2 corresponding to a magenta image signal, a laser beam B3 corresponding to a cyan image signal, and a laser beam B4 corresponding to a black image signal to a photoconductive drum 21 for yellow, a photoconductive drum 22 for magenta, a photoconductive drum 23 for cyan, and a photoconductive drum 24 for black, respectively.

The photoconductive drums 21, 22, 23, and 24 are arrayed in a substantially horizontal direction at fixed intervals. A transfer belt 25 is provided above the photoconductive drums 21, 22, 23, and 24. The transfer belt 25 is laid over a drive roller 26, guide rollers 27, 28, and 29, and a driven roller 30. The transfer belt 25 receives power from the drive roller 26 and rotates in the counterclockwise direction. The guide roller 27 is provided to freely move up and down. The guide roller 27 receives the rotational motion of a cam (a third cam) 31 and moves to the photoconductive drum 21 side to thereby displace the transfer belt 25 to the photoconductive drums 21, 22, 23, and 24 side.

Primary transfer rollers 41, 42, 43, and 44 are provided to freely move up and down in positions opposed to the photoconductive drums 21, 22, 23, and 24, respectively. The primary transfer rollers 41, 42, 43, and 44 are displaced (lowered) to the transfer belt 25 side to thereby rotate while pressing the transfer belt 25 against and bringing the same into contact with the photoconductive drums 21, 22, 23, and 24 and transfer visible images on the photoconductive drums 21, 22, 23, and 24 onto the transfer belt 25.

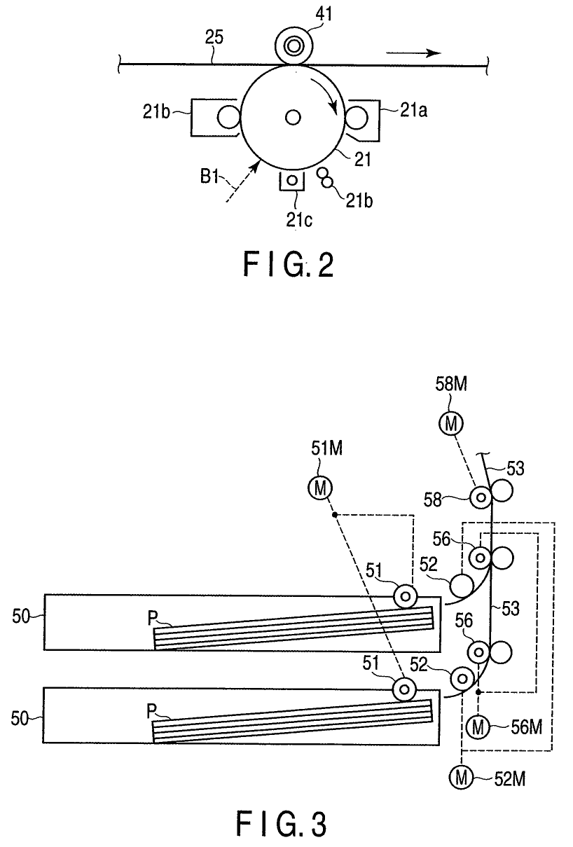

The photoconductive drum 21 and a configuration of the periphery thereof are shown in FIG. 2. A cleaner 21a, a charge removing lamp 21b, a charging unit 21c, and a developing unit 21d are sequentially disposed around the photoconductive drum 21. The cleaner 21a removes a developer remaining on the surface of the photoconductive drum 21. The charge removing lamp 21b removes electric charge remaining on the surface of the photoconductive drum 21. The charging unit 21c applies high voltage to the photoconductive drum 21 to thereby charge the surface of the photoconductive drum 21 with static electric charge. The laser beam B1 emitted from the exposing unit 11 is irradiated on the surface of the photoconductive drum 21 subjected to the charging. An electrostatic latent image is formed on the surface of the photoconductive drum 21 by the irradiation of the laser beam B1. The developing unit 21d supplies a yellow developer (toner) to the surface of the photoconductive drum 21 to thereby develop the electrostatic latent image on the surface of the photoconductive drum 21 in yellow and visualize the same.

The other photoconductive drums 22, 23, and 24 and configurations of peripheries thereof are the same as the above. Therefore, explanation of the photoconductive drums 22, 23, and 24 and the configurations is omitted.

Plural paper feeding cassettes 50 are provided below the exposing unit 11. The paper feeding cassettes 50 store a large number of paper sheets P of sizes different from one another. Pickup rollers 51 and paper feeding rollers 52 are provided in positions opposed to the paper feeding cassettes 50, respectively. Each of the pickup rollers 51 extracts one paper sheet P from each of the paper feeding cassettes 50. Each of the paper feeding rollers 52 delivers the paper sheet P extracted by the pickup roller 51 to a conveying path 53.

The conveying path 53 extends to a paper discharge port 54 in an upper part through a position opposed to the driven roller 30. The paper discharge port 54 faces a paper discharge tray 55 that continues to an outer peripheral surface of the main body 1.

Conveying rollers 56 are provided near the paper feeding rollers 52, respectively. A secondary transfer roller 57 is provided in a position opposed to the driven roller 30 in the conveying path 53 across the transfer belt 25. Registration rollers 58 are provided in a position before the driven roller 30 and the secondary transfer roller 57. The registration rollers 58 once put the paper sheet P fed by the conveying rollers 56 on standby and feed the paper sheet P into between the transfer belt 25 and the secondary transfer roller 57 at timing when a top position of the visible images on the transfer belt 25 and a leading end of the paper sheet P coincide with each other. The secondary transfer roller 57 transfers the visible images transferred on the transfer belt 25 onto the paper sheet P.

In the conveying path 53, a heat roller 59 for heat fixing and a press-contact roller 60 set in contact with the heat roller 59 are provided in a position further on a downstream side than the secondary transfer roller 57. Paper discharge rollers 61 are provided at a terminal end of the conveying path 53.

A conveying path 62 for reversing the front and the back of the paper sheet P is provided from the terminal end of the conveying path 53 to a position on an upstream side of the registration roller 58. Paper feeding rollers 63, 64, and 65 are provided in the conveying path 62. The paper sheet P that reaches the terminal end of the conveying path 53 is returned to the conveying path 53 through the conveying path 62, whereby the visible images on the transfer belt 25 are transferred onto a rear surface of the paper sheet P as well.

As shown in FIG. 3, one of the pickup rollers 51 is selectively actuated by the power of a stepping motor 51M. The respective paper feeding rollers 52 receive the power of a stepping motor 52M and operate. The conveying rollers 56 receive the power of a stepping motor 56M and operate. The respective registration rollers 58 receive the power of a stepping motor 58M and operate.

On the other hand, a cleaner 36 is provided in a position opposed to the drive roller 26 across the transfer belt 25. The cleaner 36 has a cleaning blade 36a set in contact with the transfer belt 25 and removes a developer remaining on the transfer belt 25.

Hooks 71, 72, 73, and 74 are provided near the primary transfer rollers 41, 42, 43, and 44. The hooks 71, 72, 73, and 74 lift shafts of the primary transfer rollers 41, 42, 43, and 44 and displace the primary transfer rollers 41, 42, 43, and 44 upward. The transfer belt 25 is separated from the surfaces of the photoconductive drums 21, 22, 23, and 24 by the displacement. The hooks 71, 72, 73, and 74 pivot during operation and lift the shafts of the primary transfer rollers 41, 42, 43, and 44. The hooks 71, 72, 73, and 74 return during non-operation and release the lifting of the primary transfer rollers 41, 42, 43, and 44. When the shafts of the primary transfer rollers 41, 42, 43, and 44 are lifted, the primary transfer rollers 41, 42, 43, and 44 are displaced upward and the transfer belt 25 is separated from the surfaces of the photoconductive drums 21, 22, 23, and 24. When the lifting of the primary transfer rollers 41, 42, 43, and 44 is released, the primary transfer rollers 41, 42, 43, and 44 are displaced downward and the transfer belt 25 is pressed against and brought into contact with the surfaces of the photoconductive drums 21, 22, 23, and 24.

After transferring the visible images of the respective colors onto the paper sheet P, the transfer belt 25 continues the rotation until developers remaining thereon are removed by the cleaner 36. However, when the transfer belt 25 continues the rotation while coming into contact with the photoconductive drums 21, 22, 23, and 24, the surfaces of the photoconductive drums 21, 22, 23, and 24 are worn and the durable life of the photoconductive drums 21, 22, 23, and 24 is reduced. Therefore, after the visible images on the transfer belt 25 are transferred onto the paper sheet P, the primary transfer rollers 41, 42, 43, and 44 are displaced upward to separate the transfer belt 25 from the surfaces of the photoconductive drums 21, 22, 23, and 24. After the developers remaining on the transfer belt 25 are removed by the cleaner 36, the primary transfer rollers 41, 42, 43, and 44 are displaced downward to bring the transfer belt 25 into contact with the photoconductive drums 21, 22, 23, and 24.

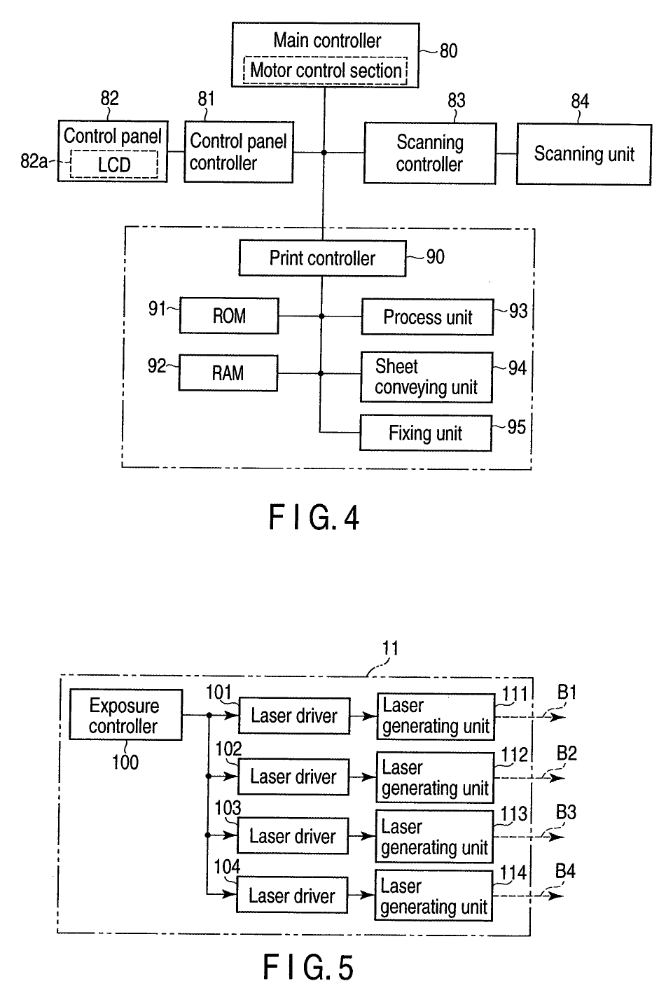

A control circuit of a main body 1 is shown in FIG. 4.

A control panel controller 81, a scanning controller 83, and a print controller 90 are connected to a main controller 80. The control panel controller 81 controls a control panel 82 for setting operation conditions. The control panel 82 has an LCD 82a as a display unit. The scanning controller 83 controls a scanning unit 84. The scanning unit 84 includes the original glass 2, the cover 3, the carriage 4, the exposure lamp 5, the reflection mirrors 6, 7, and 8, the magnification lens block 9, and the CCD 10. The scanning unit 84 scans an image of an original set on the original glass 2 through optical main scanning and sub-scanning.

A ROM 91 for storing a control program and a test pattern image described later, a RAM 92 for storing data, a process unit 93, a sheet conveying unit 94, and a fixing unit 95 are connected to the print controller 90.

The process unit 93 includes the exposing unit 11, the photoconductive drums 21, 22, 23, and 24, the configuration of the peripheries of the photoconductive drums shown in FIG. 2, the transfer belt 25, the drive roller 26, the guide rollers 27, 28, and 29, the driven roller 30, the primary transfer rollers 41, 42, 43, and 44, the secondary transfer roller 57, and the hooks 71, 72, 73, and 74. The process unit 93 exposes the photoconductive drums 21, 22, 23, and 24 with laser beams to thereby print a scanned image of the scanning unit 84 on the paper sheet P.

A configuration of the exposing unit 11 is shown in FIG. 5. The exposing unit 11 includes an exposure controller 100, laser drivers 101, 102, 103, and 104, and laser generating units 111, 112, 113, and 114. The exposing unit 11 exposes the surfaces of the photoconductive drums 21, 22, 23, and 24 through main scanning and sub-scanning by laser beams emitted from the laser generating units 111, 112, 113, and 114 to thereby form electrostatic latent images corresponding to the scanned image of the scanning unit 84 on the photoconductive drums 21, 22, 23, and 24.

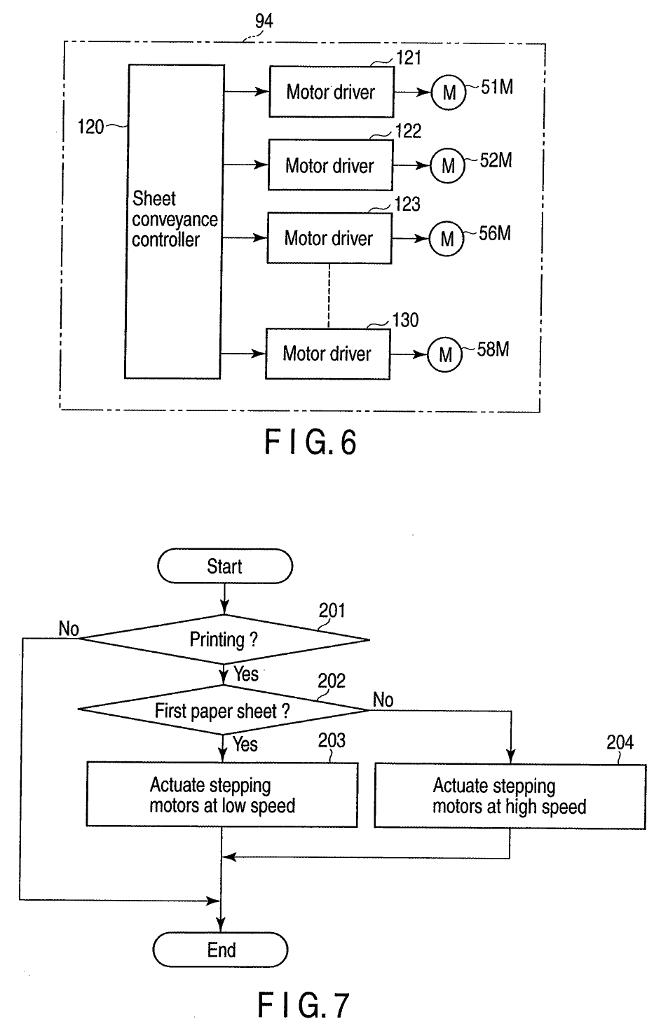

A configuration of a main part of the sheet conveying unit 94 is shown in FIG. 6. The sheet conveying unit 94 includes a sheet conveyance controller 120 for controlling to drive the stepping motors 51M, 52M, 56M, and 58M according to commands from the main controller 80 and the print controller 90, motor driver 121, 122, 123, and 130 that operate at speed corresponding to a command from the sheet conveyance controller 120, and the stepping motors 51M, 52M, 56M, and 58M that are driven by the motor drivers 121, 122, 123, and 130.

The main controller 80 includes a motor control section described in (1) below as a main function concerning the driving control for the stepping motors 51M, 52M, and 56M.

(1) A motor control section that actuates, in printing, the stepping motors 51M, 52M, and 56M at low speed when a first paper sheet P is fed from the paper feeding cassettes 50 to the process unit and actuates the stepping motors 51M, 52M, and 56M at high speed when second and subsequent paper sheets P are fed.

Actions are explained with reference to a flowchart shown in FIG. 7.

When a start key of the control panel 82 is turned on, an image of an original placed on the original glass 2 is scanned by the scanning unit 84. Electrostatic latent images corresponding to the scanned image are formed on the photoconductive drums 21, 22, 23, and 24, respectively. The electrostatic latent image formed on the photoconductive drums 21, 22, 23, and 24 are developed by a yellow developer, a magenta developer, a cyan developer, and a black developer and visualized. The visualized images are transferred onto the transfer belt 25.

According to the turn-on of the start key, the stepping motors 51M, 52M, and 56M operate. One of the pickup rollers 51 is rotated by the power of the stepping motor 51M and one paper sheet P is extracted from one of the paper feeding cassettes 51. The extracted paper sheet P is delivered to the conveying path 53 by the rotation of one of the paper feeding rollers 52 that receives the power of the stepping motor 52M. The delivered paper sheet P is fed to the registration rollers 58 by the rotation of the conveying rollers 56 that receive the power of the stepping motor 56M.

The registration rollers 58 once put the paper sheet P fed from the conveying rollers 56 on standby and feed the paper sheet P into between the transfer belt 25 and the secondary transfer roller 57 at timing when a top position of the visible images on the transfer belt 25 and a leading end of the paper sheet P coincide with each other. The transfer roller 57 transfers the visible images of the respective colors on the transfer belt 25 onto the paper sheet P.

The paper sheet P having the visible images of the respective colors transferred thereon is fed to between the heat roller 59 and the press-contact roller 60. The heat roller 59 thermally fixes the visible images on the paper sheet P. The paper sheet P that passes through the heat roller 59 is discharged from the paper discharge port 54.

In the printing (YES in Act 201), when the pickup roller 51, the paper feeding roller 52, and the conveying rollers 56 extract and convey the first paper sheet P (YES in Act 202), the stepping motors 51M, 52M, and 56M operate at low speed (Act 203). In other words, the paper feeding roller 52 and the conveying rollers 56 rotate at low speed and the paper sheet P is slowly extracted and conveyed.

In the transfer of the visible images onto the first paper sheet P, it is necessary to wait for startup of various components. Therefore, even if the pickup roller 51, the paper feeding roller 52, and the conveying rollers 56 rotate at low speed and the paper sheet P is slowly extracted and conveyed, the transfer and the printing are not hindered.

In particular, when the stepping motors 51M, 52M, and 56M operate at low speed and the pickup roller 51, the paper feeding roller 52, and the conveying rollers 56 rotate at low speed, it is possible to reduce extraction sound and conveyance sound of the paper sheet P. In other words, large sound does not echo in a silent room.

When second and subsequent paper sheets P are fed (NO in Act 202), the stepping motors 51M, 52M, and 56M operate at normal high speed (Act 204). According to the high-speed operation, the second and subsequent paper sheets P are extracted at high speed and conveyed at high speed.

In the printing of the visible images on the second and subsequent paper sheets P, it is unnecessary to wait for startup of the various components. Therefore, the pickup roller 51, the paper feeding roller 52, and the conveying rollers 56 are rotated at original high speed. According to the high-speed rotation, it is possible to increase printing speed.

In the explanation in the embodiment, the two paper feeding cassettes 50 are provided. However, the number of paper feeding cassettes is not limited. The two pickup rollers 51 are selectively driven by one stepping motor 51M. However, an exclusive stepping motor 51M may be used for each of the pickup rollers 51.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a process unit which includes image bearing members and prints images formed on the image bearing members on a paper sheet;
at least one paper feeding cassette which stores the paper sheet;
plural rollers which extract one paper sheet from the paper feeding cassette and feed the extracted paper sheet to the process unit;
motors which drive the rollers; and
a control section which actuates, in the printing, the motors at low speed when a first paper sheet is fed from the paper feeding cassette to the process unit and actuates the motors at high speed when second and subsequent paper sheets are fed to the process unit.

2. The apparatus according to claim 1, wherein the image bearing members are at least one photoconductive drum and a transfer belt which rotates while coming into contact with a surface of the photoconductive drum.

3. The apparatus according to claim 2, wherein the process unit includes:
a charging unit which charges the surface of the photoconductive drum;
an exposing unit which forms a latent image on the photoconductive drum by exposing the surface of the photoconductive drum charged by the charging unit;
a developing unit which develops the latent image formed on the surface of the photoconductive drum;
a primary transfer roller which transfers an image on the photoconductive drum developed by the developing unit onto the transfer belt; and
a secondary transfer roller which transfers an image transferred onto the transfer belt by the primary transfer roller onto a paper sheet.

4. The apparatus according to claim 3, wherein the primary transfer roller transfers the image on the photoconductive drum developed by the developing unit onto the transfer belt by rotating while pressing the transfer belt against and bringing the same into contact with the surface of the photoconductive drum.

5. The apparatus according to claim 1, wherein the plural rollers are a pickup roller which extracts one paper sheet from the feeding cassette, a paper feeding roller which delivers the paper sheet extracted by the pickup roller, conveying rollers which convey the paper sheet delivered by the paper feeding roller, and registration rollers which feeds the paper sheets conveyed by the conveying rollers into between the transfer belt and the secondary transfer roller.

6. The apparatus according to claim 5, wherein the motors are a stepping motor which drives the pickup roller, a stepping motor which drives the paper feeding roller, a stepping motor which drives the conveying rollers, and a stepping motor which drives the registration rollers.

7. The apparatus according to claim 1, wherein the image bearing members are plural photoconductive drums and a transfer belt which rotates while coming into contact with surfaces of the photoconductive drums.

8. The apparatus according to claim 7, wherein the process unit includes:
plural charging units which charge the surfaces of the photoconductive drums;
an exposing unit which exposes the surfaces of the photoconductive drums charged by the charging units to thereby form latent images on the photoconductive drums;
plural developing units which develop the latent images formed on the surfaces of the photoconductive drums;
plural primary transfer rollers which transfer the images on the photoconductive drums developed by the developing units onto the transfer belt; and
a secondary roller which transfers the images transferred onto the transfer belt by the primary transfer rollers onto a paper sheet.

9. The apparatus according to claim 8, wherein
the photoconductive drums are a photoconductive drum for black, a photoconductive drum for cyan, a photoconductive drum for magenta, and a photoconductive drum for yellow,
the developing units are a developing unit for yellow which develops in yellow a latent image formed on a surface of the photoconductive drum for yellow, a developing unit for cyan which develops in cyan a latent image formed on a surface of the photoconductive drum for cyan, a developing unit for magenta which develops in magenta a latent image formed on a surface of the photoconductive drum for magenta, and a developing unit for black which develops in black a latent image formed on a surface of the photoconductive drum for black, and
the primary transfer rollers transfer the images on the photoconductive drums developed by the developing units onto the transfer belt by rotating while pressing the transfer belt against and bringing the same into contact with the surfaces of the photoconductive drums.

10. An image forming apparatus comprising:
a scanning unit which optically scans an image of an original;
a process unit which has image bearing members and exposes the image bearing members according to the scanned image of the scanning unit or an input image from the outside to thereby form images on the image bearing members and print the images formed on the image bearing members on a paper sheet;
at least one paper feeding cassette which stores the paper sheet;
plural rollers which extract one paper sheet from the paper feeding cassette and feed the paper sheet to the process unit;
motors which drive the rollers; and
a control section which actuates, in the printing, the motors at low speed when a first paper sheet is fed from the paper feeding cassette to the process unit and actuates the motors at high speed when second and subsequent paper sheets are fed to the process unit.

11. The apparatus according to claim 10, wherein the image bearing members are at least one photoconductive drum and a transfer belt which rotates while coming into contact with a surface of the photoconductive drum.

12. The apparatus according to claim 11, wherein the process unit includes:
a charging unit which charges the surface of the photoconductive drum;
an exposing unit which forms a latent image on the photoconductive drum by exposing the surface of the photoconductive drum charged by the charging unit;
a developing unit which develops the latent image formed on the surface of the photoconductive drum;
a primary transfer roller which transfers an image on the photoconductive drum developed by the developing unit onto the transfer belt; and
a secondary transfer roller which transfers an image transferred onto the transfer belt by the primary transfer roller onto a paper sheet.

13. The apparatus according to claim 12, wherein the primary transfer roller transfers the image on the photoconductive drum developed by the developing unit onto the transfer belt by rotating while pressing the transfer belt against and bringing the same into contact with the surface of the photoconductive drum.

14. The apparatus according to claim 10, wherein the plural rollers are a pickup roller which extracts one paper sheet from the feeding cassette, a paper feeding roller which delivers the paper sheet extracted by the pickup roller, conveying rollers which convey the paper sheet delivered by the paper feeding roller, and registration rollers which feeds the paper sheets conveyed by the conveying rollers into between the transfer belt and the secondary transfer roller.

15. The apparatus according to claim 14, wherein the motors are a stepping motor which drives the pickup roller, a stepping motor which drives the paper feeding roller, a stepping motor which drives the conveying rollers, and a stepping motor which drives the registration rollers.

16. The apparatus according to claim 10, wherein the image bearing members are plural photoconductive drums and a transfer belt which rotates while coming into contact with the surfaces of the photoconductive drums.

17. The apparatus according to claim 16, wherein the process unit includes:
plural charging units which charge the surfaces of the photoconductive drums;
an exposing unit which exposes the surfaces of the photoconductive drums charged by the charging units to thereby form latent images on the photoconductive drums;
plural developing units which develop the latent images formed on the surfaces of the photoconductive drums;
plural primary transfer rollers which transfer the images on the photoconductive drums developed by the developing units onto the transfer belt; and
a secondary transfer roller which transfers the images transferred onto the transfer belt by the primary transfer rollers onto a paper sheet.

18. The apparatus according to claim 17, wherein
the photoconductive drums are a photoconductive drum for black, a photoconductive drum for cyan, a photoconductive drum for magenta, and a photoconductive drum for yellow,
the developing units are a developing unit for yellow which develops in yellow a latent image formed on a surface of the photoconductive drum for yellow, a developing unit for cyan which develops in cyan a latent image formed on a surface of the photoconductive drum for cyan, a developing unit for magenta which develops in magenta a latent image formed on a surface of the photoconductive drum for magenta, and a developing unit for black which develops in black a latent image formed on a surface of the photoconductive drum for black, and
the primary transfer rollers transfer the images on the photoconductive drums developed by the developing units onto the transfer belt by rotating while pressing the transfer belt against and bringing the same into contact with the surfaces of the photoconductive drums.

19. A control method of an image forming apparatus including a process unit which includes image bearing members and prints images formed on the image bearing members on a paper sheet, at least one paper feeding cassette which stores the paper sheet, plural rollers which extract one paper sheet from the paper feeding cassette and feed the extracted paper sheet to the process unit, and motors which drive the rollers, the control method comprising:
actuating, in the printing, the motors at low speed when a first paper sheet is fed from the paper feeding cassette to the process unit and actuating the motors at high speed when second and subsequent paper sheets are fed to the process unit.
